(19) United States
(12) Patent Application Publication
(10) Pub. No.: US 2023/0008354 A1
(43) Pub. Date: Jan. 12, 2023

(54) IDLE MODE PROCESSING METHOD, USER EQUIPMENT AND CHIP

(71) Applicant: GUANGDONG OPPO MOBILE TELECOMMUNICATION CORP., LTD., Dongguan (CN)

(72) Inventors: Xin XU, Palo Alto, CA (US); Yongsheng SHI, Palo Alto, CA (US)

(21) Appl. No.: 17/934,353

(22) Filed: Sep. 22, 2022

Related U.S. Application Data
(63) Continuation of application No. PCT/CN2021/087037, filed on Apr. 13, 2021.
(60) Provisional application No. 63/009,231, filed on Apr. 13, 2020.

(51) Int. Cl. H04W 52/02

(52) U.S. Cl. CPC H04W 52/0225

(57) ABSTRACT

An idle mode processing method executable in a user equipment (UE) is provided, and includes: determining a UE mobility state of the UE; applying a speed scaling factor associated with a low mobility state of the UE to an idle mode processing parameter in response to the UE is in the low mobility state, the idle mode processing parameter is utilized for a criterion for triggering a specific idle mode operation in the idle mode, and the low mobility state is a state where a speed of the UE is lower than a first speed threshold; and adjusting the criterion using the speed scaling factor to delay or skip execution of the specific idle mode operation.

### CROSS REFERENCE TO RELATED APPLICATIONS

This application is a continuation of International Patent Application No. PCT/CN2021/087037, filed Apr. 13, 2021, which claims priority to U.S. Patent Application No. 63/009,231 filed Apr. 13, 2020, the entire disclosures of which are incorporated herein by reference.

### TECHNICAL FIELD

The present disclosure relates to the field of communication systems, and more particularly, to an idle mode processing method, a user equipment, and a chip.

### BACKGROUND

Wireless communication systems, such as the third-generation (3G) of mobile telephone standards and technology are well known. Such 3G standards and technology have been developed by the Third Generation Partnership Project (3GPP). The 3rd generation of wireless communications has generally been developed to support macro-cell mobile phone communications. Communication systems and networks have developed towards being a broadband and mobile system. In cellular wireless communication systems, user equipment (UE) is connected by a wireless link to a radio access network (RAN). The RAN comprises a set of base stations (BSs) which provide wireless links to the UEs located in cells covered by the base station, and an interface to a core network (CN) which provides overall network control. As will be appreciated the RAN and CN each conduct respective functions in relation to the overall network. The 3rd Generation Partnership Project has developed the so-called Long Term Evolution (LTE) system, namely, an Evolved Universal Mobile Telecommunication System Territorial Radio Access Network, (E-UTRAN), for a mobile access network where one or more macro-cells are supported by a base station known as an eNodeB or eNB (evolved NodeB). More recently, LTE is evolving further towards the so-called 5G or NR (new radio) systems where one or more cells are supported by a base station known as a gNB.

### Technical Problem

In response to a UE, such as a cell phone, being in an idle mode where no active circuit switched (CS) or packet switched (PS) call or signaling connection is established for the UE, the UE regularly wakes up to receive paging, measure, and evaluate a camped cell, known as a serving cell, and neighbor cells and ensure the UE is always camping on best cells. After the paging, cell measurement and evaluation, the UE transits to the idle mode to sleep and save battery life. Currently, the pace of UE wake-up, paging receiving, and cell measurement is the same in all scenarios. When a UE is moving at mid to high speed, such as on a car, a bus, or a train, surrounding environment and cell conditions change rapidly, and the UE should wake up for the paging receiving, and cell measurement on a timely basis. However, it may be unnecessary for a UE in low mobility, such as in pedestrian or stationary cases, to have the same pace.

Additionally, in a live network, a UE doing frequent cell reselection may lead to excessive battery drain because of the following reasons.

1. Network misconfiguration—
A good signal cell has lower reselection priority while a bad signal cell has higher reselection priority;
   2. UE located in a border area of multiple cells—
All cell measurement results are very close and sensitive.

Hence, it is desirable to improve the pace of cell measurement and reselection.

### SUMMARY

In a first aspect, an embodiment of the disclosure provides an idle mode processing method executable in a user equipment (UE), and the method includes: determining a UE mobility state of the UE; applying a speed scaling factor associated with a low mobility state of the UE to an idle mode processing parameter in response to the UE being in the low mobility state, the idle mode processing parameter is utilized for a criterion for triggering a specific idle mode operation in the idle mode, and the low mobility state is a state where a speed of the UE is lower than a first speed threshold; and adjusting the criterion using the speed scaling factor to delay or skip execution of the specific idle mode operation.

In a second aspect, an embodiment of the disclosure provides a user equipment (UE), and the UE includes: a processor configured to execute operations, the operations comprise: determining a UE mobility state of the UE; applying a speed scaling factor associated with a low mobility state of the UE to an idle mode processing parameter in response to the UE being in the low mobility state, the idle mode processing parameter is utilized for a criterion for triggering a specific idle mode operation in the idle mode, and the low mobility state is a state where a speed of the UE is lower than a first speed threshold; and adjusting the criterion using the speed scaling factor to delay or skip execution of the specific idle mode operation.

In a third aspect, an embodiment of the disclosure provides a chip, and the chip includes a processor, configured to call and run a computer program stored in a memory, to cause a device in which the chip is installed to execute above method.

### BRIEF DESCRIPTION OF THE DRAWINGS

In order to more clearly illustrate the embodiments of the present disclosure or related art, the following figures will be described in the embodiments and briefly introduced. It is obvious that the drawings are merely some embodiments of the present disclosure, a person having ordinary skill in this field can obtain other figures according to these figures without paying creative effort.

FIG. 1 illustrates a structural block view of a telecommunication system.

FIG. 2 illustrates a flowchart of showing a disclosed method according to an embodiment of the present disclosure.

FIG. 3 illustrates a flowchart showing the disclosed method for adjusting inter/interRAT frequency measurement interval according to another embodiment of the present disclosure.

FIG. 4 illustrates a flowchart showing the disclosed method for ignoring cell priority according to another embodiment of the present disclosure.

FIG. 5 illustrates a flowchart showing the disclosed method for adjusting cell measurement interval according to another embodiment of the present disclosure.

FIG. 6 illustrates a flowchart showing the disclosed method for adjusting cell reselection interval according to another embodiment of the present disclosure.

FIG. 7 illustrates a flowchart showing the disclosed method for adjusting cell hysteresis according to another embodiment of the present disclosure.

FIG. 8 illustrates a structural block view showing a system for wireless communication according to an embodiment of the present disclosure.

### DETAILED DESCRIPTION

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

It should be understood that term “and/or” in the present disclosure is only an association relationship describing the associated objects, which means that there can be three kinds of relationships; for example, A and/or B can mean three situations including: A exists alone, A and B exist simultaneously, and B exists alone.

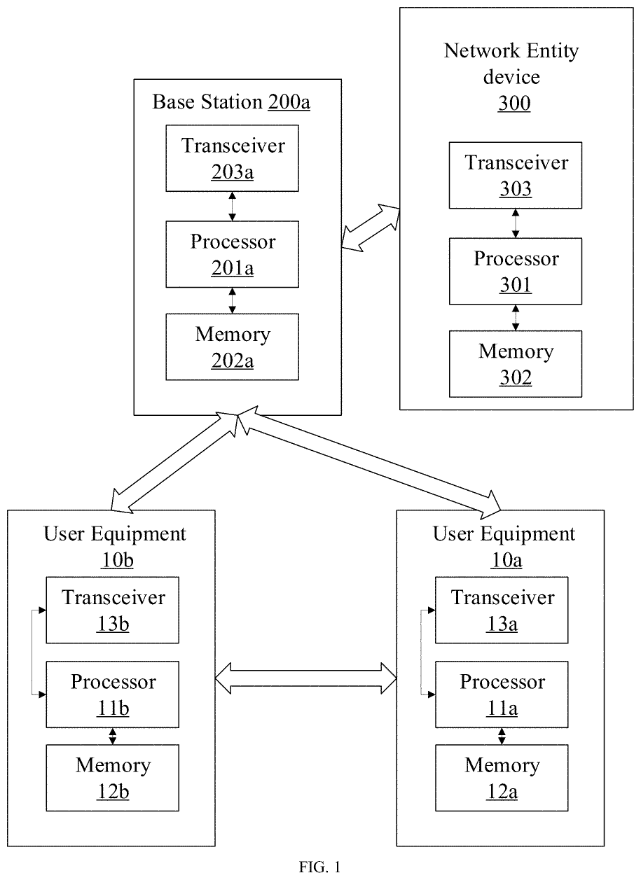

With reference to FIG. 1, a telecommunication system including a UE 10a, a UE 10b, a base station (BS) 200a, and a network entity device 300 executes the disclosed method according to an embodiment of the present disclosure. FIG. 1 is shown for illustrative not limiting, and the system may comprise more UEs, BSs, and CN entities. Connections between devices and device components are shown as lines and arrows in the FIG. 1. The UE 10a may include a processor 11a, a memory 12a, and a transceiver 13a. The UE 10b may include a processor 11b, a memory 12b, and a transceiver 13b. The base station 200a may include a processor 201a, a memory 202a, and a transceiver 203a. The network entity device 300 may include a processor 301, a memory 302, and a transceiver 303. Each of the processors 11a, 11b, 201a, and 301 may be configured to implement proposed functions, procedures and/or methods described in the description. Layers of radio interface protocol may be implemented in the processors 11a, 11b, 201a, and 301. Each of the memory 12a, 12b, 202a, and 302 operatively stores a variety of programs and information to operate a connected processor. Each of the transceivers 13a, 13b, 203a, and 303 is operatively coupled with a connected processor, transmits and/or receives radio signals or wireline signals. The UE 10a may be in communication with the UE 10b through a sidelink. The base station 200a may be an eNB, a gNB, or one of other types of radio nodes, and may configure radio resources for the UE 10a and UE 10b.

Each of the processors 11a, 11b, 201a, and 301 may include an application-specific integrated circuits (ASICs), other chipsets, logic circuits and/or data processing devices. Each of the memory 12a, 12b, 202a, and 302 may include read-only memory (ROM), a random access memory (RAM), a flash memory, a memory card, a storage medium and/or other storage devices. Each of the transceivers 13a, 13b, 203a, and 303 may include baseband circuitry and radio frequency (RF) circuitry to process radio frequency signals. When the embodiments are implemented in software, the techniques described herein can be implemented with modules, procedures, functions, entities and so on, that perform the functions described herein. The modules can be stored in a memory and executed by the processors. The memory can be implemented within a processor or external to the processor, in which those can be communicatively coupled to the processor via various means are known in the art.

The network entity device 300 may be a node in a CN. CN may include LTE CN or 5G core (5GC) which includes user plane function (UPF), session management function (SMF), mobility management function (AMF), unified data management (UDM), policy control function (PCF), control plane (CP)/user plane (UP) separation (CUPS), authentication server (AUSF), network slice selection function (NSSF), and the network exposure function (NEF).

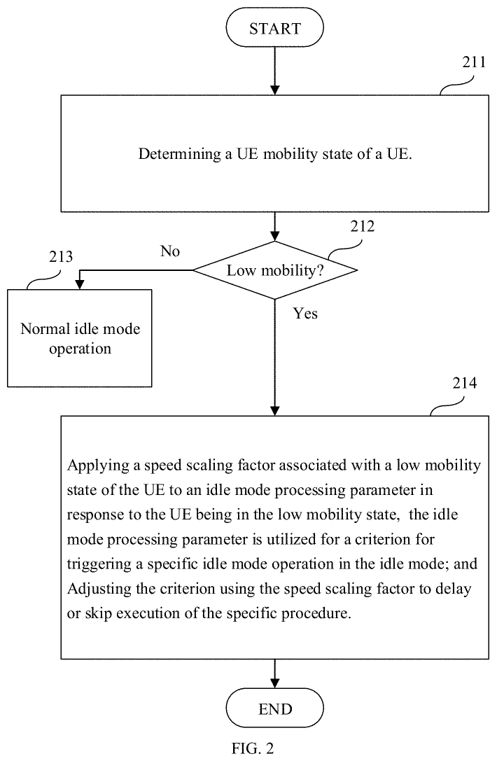

With reference to FIG. 2, a UE executes the disclosed idle mode processing method. An example of the UE in the description may include one of the UE 10a or UE 10b. An example of the base station in the description may include the base station 200a. The UE determines a UE mobility state of the UE (block 211) and determines whether the UE is in low mobility (block 212). The UE may be in one mobility state among a plurality of mobility states that reflect the movement speed of the UE. A low mobility state of the UE is a state where a movement speed of the UE is lower than a first speed threshold. In response to the UE not being in low mobility, the UE performs normal idle mode operations (block 213), such as inter/interRAT frequency measurement, cell reselection priority receiving, cell measurement, cell reselection, cell hysteresis processing, paging receiving, and UE wake-up.

In response to the UE not being in low mobility, the UE applies a speed scaling factor associated with a low mobility state of the UE to an idle mode processing parameter (block 214). The idle mode processing parameter is utilized for a criterion for triggering a specific idle mode operation in the idle mode. For example, the specific idle mode operation may comprise one of the inter/interRAT frequency measurement, the cell reselection priority receiving, the cell measurement, the cell reselection, the cell hysteresis processing, the paging receiving, and the UE wake-up. The UE adjusts the criterion using the speed scaling factor to delay or skip execution of the specific idle mode operation (block 214).

During the UE wake-up from the idle mode to check paging and any incoming call from the network to the UE, it's rare to receive an incoming call. The UE reading paging in every paging occasions can consume power.

The disclosure provides a comprehensive solution to adjust UE idle procedure and improve UE power efficiency in the idle mode. The disclosed method includes at least four parts to help low mobility or stationary UEs:

1. Extending speed Scaling Rules to low mobility and stationary case;
2. Adjusting the pace of measurement scheduling;
3. Adjusting related parameters to reduce the frequency of the cell reselection;
4. Skipping paging decoding to reduce power consumption.
Embodiments of the disclosed method may work together to help reduce the number of wake up, idle measurement and the cell reselection, and the paging decoding, and improves power consumption and battery life of the UE.

### Extending Speed Scaling Rules for Low Mobility and Stationary Case:

3GPP has defined SpeedStateScaleFactors (SSSF) for UEs in medium-mobility and high-mobility in technical specification (TS) 36.331/38.331 as:

{0.25, 0.5, 0.75, 1}.
The disclosed method extends the set of SSSF to support UEs in low mobility and stationary UEs. The SSSF is referred to as a type of speed scaling factors in the disclosure. The set of SSSF may be redefined as:
{0.25, 0.5, 0.75, 1, 2, 4, 8}.
The set of SSSF has extended elements {2, 4, 8} in an embodiment of the disclosure.

Additionally, 3GPP has defined “Speed dependent ScalingFactor for Qhyst” (SSFQ) for the UEs in medium-mobility and high-mobility as:

{dB-6, dB-4, dB-2, dB0}.
The disclosed method extends the set of SSFQ to support UEs in the low mobility and the stationary UEs. The SSFQ is referred to as another type of speed scaling factors in the disclosure.
The set of SSFQ may be redefined as:
{dB-6, dB-4, dB-2, dB0, dB2, dB4, dB6}.
The set of SSFQ has extended elements {dB2, dB4, dB6} in an embodiment of the disclosure. Embodiments of the disclosed method may use the speed scaling factors as detailed in the following.

### Adjusting the Pace of Idle Measurement Scheduling:

During the idle mode, the UE may schedule the inter frequency and the interRAT frequency measurement. In response to a cell measurement result of a serving cell of the UE being good, for example, above certain threshold which may be configurable, the UE may adjust the scheduling of the inter frequency and the interRAT frequency measurement to save the power.

### Adjusting the Pace of Idle Measurement Scheduling for Low Mobility UE:

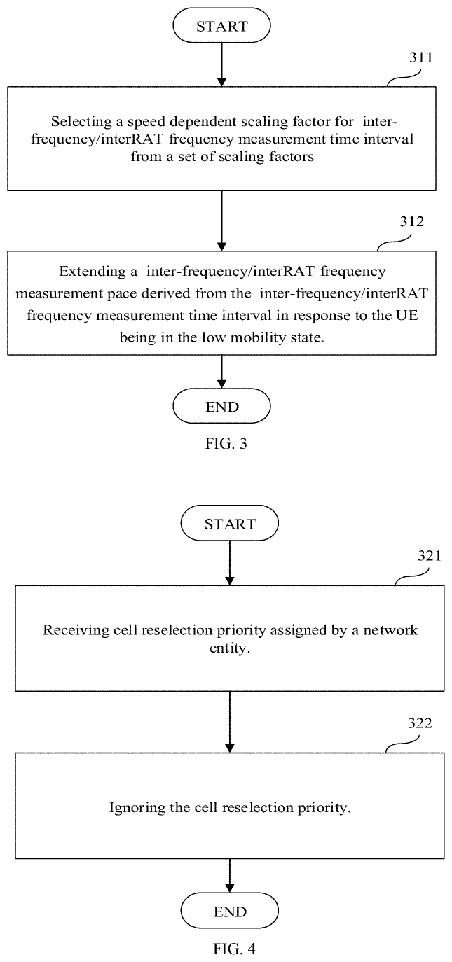

In an embodiment of the method of FIG. 2, the idle mode processing parameter is an inter/interRAT frequency measurement time interval, the speed scaling factor is a speed dependent scaling factor sf-Low for the inter/interRAT frequency measurement time interval. With reference to FIG. 3, block 214 further comprises the following operations. The UE selects the speed dependent scaling factor sf-Low for the inter/interRAT frequency measurement time interval from a set of scaling factors (block 311) and extends an inter/interRAT frequency measurement pace derived from the inter/interRAT frequency measurement time interval in response to the UE being in the low mobility state (block 312). The UE may schedule the inter/interRAT frequencies as every N measurement instances UE usually scheduled, where N>1, and N may be one of the values in the set of SSSFs: {0.25, 0.5, 0.75, 1, 2, 4, 8}. A measurement instance may be defined as the inter/interRAT frequency measurement time interval in a unit of millisecond (ms).

The UE may select a greater value in a set of the scaling factors in response to the speed of the UE being lower than a second speed threshold, thus to skip more scheduling of measurements. The UE may select a smaller value in the set of the scaling factors in response to the speed of the UE being greater than a third speed threshold, thus to skip less scheduling of measurements. The UE may update N based on a speed detected. In the embodiment of the disclosed method, UE schedules less frequencies measurements during the idle mode in the low mobility/stationary case. The second speed threshold may be different from the first speed threshold. In an example, the second speed threshold may be the same as the third speed threshold. In another example, the second speed threshold may be different from the third speed threshold.

### Adjusting the Pace of Idle Measurement Scheduling for Stationary UE:

The UE in a stationary state may stop idle the inter/interRAT frequency measurement completely to save power when possible.

### Adjusting Related Parameters to Reduce the Frequency of Cell Reselection:

After gathering cell measurement results of the serving/neighbor cells, the UE may perform cell reselection evaluation.

UE camped on a good cell near another candidate cell that meeting certain reselection criteria in 3GPP 36.304/38.304, the UE may reselect and camp on the candidate cell. However, the cell reselection may be unnecessary for the UE in low mobility. An embodiment of the method reduces opportunities or operations of the cell reselection to save the power. The embodiment of the disclosed method may also address the problem of network misconfiguration that leads to the frequent cell reselection.

Ignore Reselection Priority Higher than Serving Cell's Priority:

A network entity may send a system information block (SIB) to the UE to assign different cell reselection priorities to every frequency.

Cells with higher priority have more possibility to be reselected by the UE to in a signal condition the same as or even lower than the serving cell. With reference to FIG. 4, in response to receiving the cell reselection priority assigned by the network entity (block 321), the UE may ignore the cell reselection priority assigned to the serving cell and one or more neighbor cells in response to the UE being in the low mobility state (block 322). The UE may ignore the cell reselection priority assigned to the one or more neighbor cells which is higher than the serving cell. Ignoring priority for those cells may comprise treating priority assigned to the one or more neighbor cells as equal to priority assigned to the serving cell. Ignoring priority for those cells during the cell reselection may reduce possibility of the cell reselection and handover operations to frequencies/cells of higher priority. Thus, the cell reselection is performed only based on cell ranking.

### Apply Extended Scaling Parameters During Reselection Evaluation:

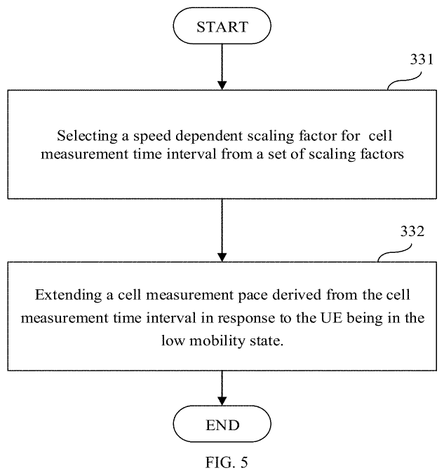

The UE can reuse extended scaling factors for UEs in low mobility. 3GPP TS 38.331 section 5.2.4.3.1 defines speed scaling factors and idle mode processing parameters for high mobility cases. In an embodiment of the method of FIG. 2, the idle mode processing parameter is a cell measurement time interval, the speed scaling factor is a speed dependent scaling factor sf-Low for the cell measurement time interval. With reference to FIG. 5, block 214 further comprises the following operations. The UE selects the speed dependent scaling factor sf-Low for the cell measurement time interval from the set of scaling factors (block 331), and extends a cell measurement pace derived from the cell measurement time interval in response to the UE being in the low mobility state (block 332). The speed dependent scaling factor sf-Low for the cell measurement time interval may comprise one value in a set {2, 4, 8}.

The UE may select a greater value in the set of the scaling factors in response to the speed of the UE being lower than the second speed threshold, thus to skip more cell measurements. The UE may select a smaller value in the set of the scaling factors in response to the speed of the UE being greater than the third speed threshold, thus to skip less cell measurements. In an example, the second speed threshold may be the same as the third speed threshold. In another example, the second speed threshold may be different from the third speed threshold.

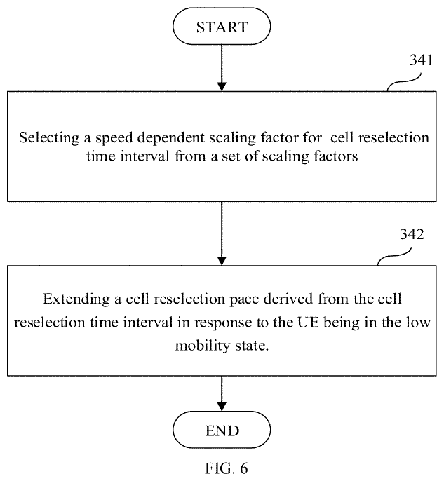

In an embodiment of the method of FIG. 2, the idle mode processing parameter is a cell reselection time interval, the speed scaling factor is a speed dependent scaling factor sf-Low for the cell reselection time interval. With reference to FIG. 6, block 214 further comprises the following operations. The UE selects the speed dependent scaling factor sf-Low for cell reselection time interval from the set of scaling factors (block 341) and extends a cell reselection pace derived from the cell reselection time interval in response to the UE being in the low mobility state (block 342). The speed dependent scaling factor sf-Low for the cell reselection time interval may comprise one value in a set {2, 4, 8}. The cell reselection time interval may be Treselection_{NR} for new radio (NR) or Treselection_{EUTRA} for LTE. The cell reselection pace may be obtained from the cell reselection time interval multiplied by the speed dependent scaling factor sf-Low.

The UE may select a greater value in the set of the scaling factors in response to the speed of the UE being lower than the second speed threshold, thus to skip more cell reselection operations. The UE may select a smaller value in the set of the scaling factors in response to the speed of the UE being greater than the third speed threshold, thus to skip less cell reselection operations. In an example, the second speed threshold may be the same as the third speed threshold. In another example, the second speed threshold may be different from the third speed threshold.

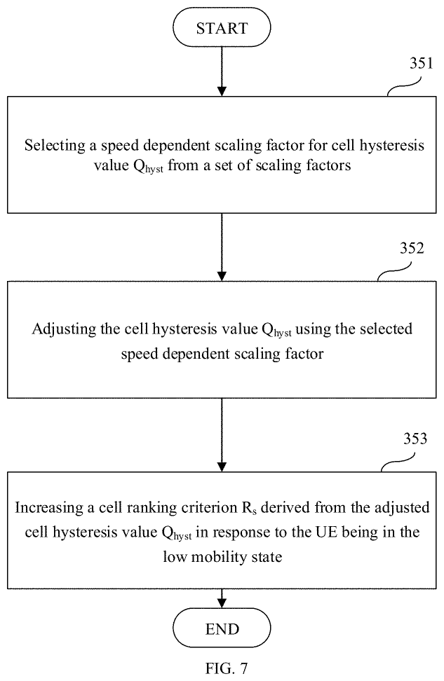

In an embodiment of the method of FIG. 2, the idle mode processing parameter is a cell hysteresis value Q_{hyst}, the speed scaling factor is the speed dependent scaling factor sf-Low for the cell hysteresis value Q_{hyst}. With reference to FIG. 7, block 214 further comprises the following operations. The UE selects the speed dependent scaling factor sf-Low for the cell hysteresis value Q_{hyst} from the set of scaling factors (block 351), adjusts the cell hysteresis value Q_{hyst} using the selected speed dependent scaling factor to generate adjusted cell hysteresis value Q_{hyst} (block 352) and increases a cell ranking criterion Rₛ derived from the adjusted cell hysteresis value Q_{hyst} in response to the UE being in the low mobility state (block 353). The SSFQ sf-Low for the cell hysteresis value Q_{hyst} may comprise one value in a set {dB2, dB4, dB6}. The adjusted cell hysteresis value Q_{hyst} may be obtained from Q_{hyst} SSFQ.

The cell hysteresis value Q_{hyst} may be Q_{hyst} for new radio (NR). The cell ranking criterion Rₛ is obtained by:

Rₛ=Qₘₑₐₛ+Q_{hyst};

where Qₘₑₐₛ represents reference signal receiving power (RSRP) measurement quantity used in cell reselection.

The UE may select a greater value sf-Low in the set of the scaling factors in response to the speed of the UE being lower than the second speed threshold, thus to skip the more cell reselection operations. The UE may select a smaller value sf-Low in the set of the scaling factors in response to the speed of the UE being greater than the third speed threshold, thus to skip the less cell reselection operations. In an example, the second speed threshold may be the same as the third speed threshold. In another example, the second speed threshold may be different from the third speed threshold.

UE may apply the following scaling rules:

If Low-mobility state is detected:
Add the sf-Low of “Speed dependent Scaling Factor for Q_{hyst}” to Q_{hyst} if broadcasted in system information;
For NR cells, multiply Treselection_{NR} by the sf-Low of “Speed dependent Scaling Factor for Treselection_{NR}” if broadcasted in system information;
For EUTRA cells, multiply Treselection_{EUTRA} by the sf-Low of “Speed dependent Scaling Factor for Treselection_{EUTRA}” if broadcasted in system information.

Because a positive SSFQ makes Q_{hyst} higher, UE may have higher possibility to stay with the serving cell and neighbor cell needs longer time (SSSF*Treselection) to pass the reselection condition, and may thus reduce the reselection operations and save the power. The UE may stop the cell measurement in response to the UE being in a stationary state.

### Skipping Paging Decoding to Reduce Power Consumption:

UE typically wakes up every paging occasion to decode paging at each discontinuous reception (DRX) cycle. In an embodiment of the disclosed method, the UE may randomly skip the paging occasion to save the power. An embodiment of the disclosed method performing paging skipping is detailed in the following.

For a certain DRX wakeup operation, the UE may decide to skip the paging decoding and the cell measurement, and can stay sleep and does not wake up, thus further saving the power of the UE.

### Randomly Skip Paging:

For N paging occasions, where N≥2, UE may skip M of N paging occasions, where (N−1)≥M≥1. The UE may randomly select positions of the skipped paging occasions. That is, the UE may skip M of N paging occasions randomly. The network may re-page the UE as appropriate.

For example, in response to N=2, M=1, UE may skip one of every two paging occasions. Specifically, the UE can randomly skip either 1^{st} or 2^{nd} paging occasion in the two paging occasions.

### Skip Wake Up:

In response to the UE bing scheduled to skip a paging occasion and needing not to perform the inter/interRAT frequency measurement and the cell measurement in a next wake-up, the UE may skip the next wake-up and continue sleep, thus saving more UE power.

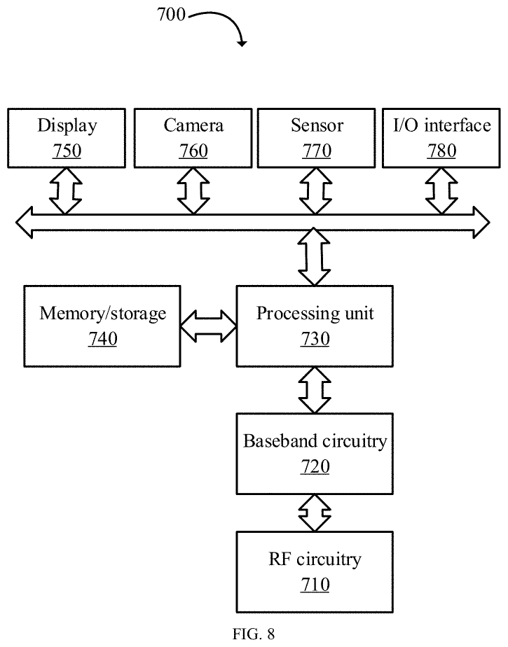

FIG. 8 is a block diagram of an example system 700 for wireless communication according to an embodiment of the present disclosure. Embodiments described herein may be implemented into the system using any suitably configured hardware and/or software. FIG. 8 illustrates the system 700 including a radio frequency (RF) circuitry 710, a baseband circuitry 720, a processing unit 730, a memory/storage 740, a display 750, a camera 760, a sensor 770, and an input/output (I/O) interface 780, coupled with each other as illustrated.

The processing unit 730 may include circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The baseband circuitry 720 may include circuitry, such as, but not limited to, one or more single-core or multi-core processors. The processors may include a baseband processor. The baseband circuitry may handle various radio control functions that enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with 5G NR, LTE, an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the UE, the eNB, or the gNB may be embodied in whole or in part in one or more of the RF circuitries, the baseband circuitry, and/or the processing unit. As used herein, “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the processing unit, and/or the memory/storage may be implemented together on a system on a chip (SOC).

The memory/storage 740 may be used to load and store data and/or instructions, for example, for system. The memory/storage 740 for one embodiment may include any combination of suitable volatile memory, such as dynamic random access memory (DRAM)), and/or non-volatile memory, such as flash memory. In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

A processor in the UE may utilize the sensor 770 to determine mobility state of the UE. The UE may be in one mobility state among a plurality of mobility state that reflect the movement speed of the UE. A low mobility state is a state where a movement speed of the UE is lower than the speed threshold. In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite. In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, etc. In various embodiments, the system may have more or less components, and/or different architectures. Where appropriate, the methods described herein may be implemented as a computer program. The computer program may be stored on a storage medium, such as a non-transitory storage medium.

The embodiment of the present disclosure is a combination of techniques/processes that can be adopted in 3GPP specification to create an end product.

A person having ordinary skill in the art understands that each of the units, algorithm, and operations described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated into another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated into one processing unit, physically independent, or integrated into one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

The disclosure provides a comprehensive solution to adjust UE idle procedure and improve UE power efficiency in the idle mode. Embodiments of the disclosed method may work together to help reduce the number of wake up, idle measurement and the cell reselection, and paging decoding, and improves power consumption and battery life of a UE.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. An idle mode processing method executable in a user equipment (UE), comprising:
determining a UE mobility state of the UE;
applying a speed scaling factor associated with a low mobility state of the UE to an idle mode processing parameter in response to the UE being in the low mobility state, wherein the idle mode processing parameter is utilized for a criterion for triggering a specific idle mode operation in the idle mode, and the low mobility state is a state where a speed of the UE is lower than a first speed threshold; and
adjusting the criterion using the speed scaling factor to delay or skip execution of the specific idle mode operation.

2. The idle mode processing method as claimed in claim 1, wherein the idle mode processing parameter comprises an inter/interRAT frequency measurement time interval, the speed scaling factor comprises a speed dependent scaling factor for the inter/interRAT frequency measurement time interval, the method further comprises:
extending an inter/interRAT frequency measurement pace derived from the inter/interRAT frequency measurement time interval in response to the UE being in the low mobility state.

3. The idle mode processing method as claimed in claim 2, wherein the speed dependent scaling factor for the inter/interRAT frequency measurement time interval comprises one value in a set of scaling factors, and the method further comprises:
selecting a greater value in the set of the scaling factors in response to the speed of the UE being lower than a second speed threshold; and
selecting a smaller value in the set of the scaling factors in response to the speed of the UE being greater than a third speed threshold.

4. The idle mode processing method as claimed in claim 2, further comprising:
stopping idle inter/interRAT frequency measurement in response to the UE being in a stationary state.

5. The idle mode processing method as claimed in claim 1, wherein the idle mode processing parameter comprises a cell measurement time interval, the speed scaling factor comprises a speed dependent scaling factor for the cell measurement time interval, the method further comprises:
extending a cell measurement pace derived from the cell measurement time interval in response to the UE being in the low mobility state.

6. The idle mode processing method as claimed in claim 5, wherein the speed dependent scaling factor for the cell measurement time interval comprises one value in a set of scaling factors, and the method further comprises:
selecting a greater value in the set of the scaling factors in response to the speed of the UE being lower than a second speed threshold; and
selecting a smaller value in the set of the scaling factors in response to the speed of the UE being greater than a third speed threshold.

7. The idle mode processing method as claimed in claim 6, wherein the speed dependent scaling factor for the cell measurement time interval comprises one value in a set {2, 4, 8}.

8. The idle mode processing method as claimed in claim 1, further comprising:
stopping cell measurement in response to the UE being in a stationary state.

9. The idle mode processing method as claimed in claim 1, wherein the idle mode processing parameter comprises a cell reselection time interval, the speed scaling factor comprises a speed dependent scaling factor for the cell reselection time interval, the method further comprises:
extending a cell reselection pace derived from the cell reselection time interval in response to the UE being in the low mobility state.

10. The idle mode processing method as claimed in claim 9, wherein the speed dependent scaling factor for the cell reselection time interval comprises one value in a set of scaling factors, and the method further comprises:
selecting a greater value in the set of the scaling factors in response to the speed of the UE being lower than a second speed threshold; and
selecting a smaller value in the set of the scaling factors in response to the speed of the UE being greater than a third speed threshold.

11. The idle mode processing method as claimed in claim 9, wherein the cell reselection pace is obtained from the cell reselection time interval multiplied by the speed dependent scaling factor.

12. The idle mode processing method as claimed in claim 9, wherein the cell reselection time interval comprises Treselection_{NR} or Treselection_{EUTRA}.

13. The idle mode processing method as claimed in claim 1, further comprising:
ignoring cell reselection priority assigned to a neighbor cell in response to the UE being in the low mobility state.

14. The idle mode processing method as claimed in claim 1, wherein the idle mode processing parameter comprises a cell hysteresis value Q_{hyst} for cell ranking criteria, the speed scaling factor comprises a speed dependent scaling factor for the cell hysteresis value Q_{hyst}, the method further comprises:
adjusting the cell hysteresis value Q_{hyst} using the selected speed dependent scaling factor to generate adjusted cell hysteresis value Q_{hyst};
increasing a cell ranking criterion Rₛ derived from the adjusted cell hysteresis value Q_{hyst} in response to the UE being in the low mobility state.

15. The idle mode processing method as claimed in claim 14, wherein the speed dependent scaling factor for the cell hysteresis value Q_{hyst} comprises one value in a set of scaling factors, and the method further comprises:
selecting a greater value in the set of the scaling factors in response to the speed of the UE being lower than a second speed threshold; and
selecting a smaller value in the set of the scaling factors in response to the speed of the UE being greater than a third speed threshold.

16. The idle mode processing method as claimed in claim 14, wherein the cell ranking criterion Rₛ is obtained by:
Rₛ=Qₘₑₐₛ+Q_{hyst};
Qₘₑₐₛ represents RSRP measurement quantity used in cell reselection.

17. The idle mode processing method as claimed in claim 1, further comprising:
skipping M of N paging occasions; or
skipping M of N paging occasions randomly.

18. The idle mode processing method as claimed in claim 1, further comprising:
skipping wake-up of the UE in response to the UE being scheduled to skip a paging occasion and needs not to perform inter/interRAT frequency measurement and cell measurement in a next wake-up.

19. A user equipment (UE), comprising:
a processor configured to execute operations, wherein the operations comprise:
determining a UE mobility state of the UE;
applying a speed scaling factor associated with a low mobility state of the UE to an idle mode processing parameter in response to the UE being in the low mobility state, wherein the idle mode processing parameter is utilized for a criterion for triggering a specific idle mode operation in the idle mode, and the low mobility state is a state where a speed of the UE is lower than a first speed threshold; and
adjusting the criterion using the speed scaling factor to delay or skip execution of the specific idle mode operation.

20. A chip, comprising:
a processor, configured to call and run a computer program stored in a memory, to cause a device in which the chip is installed to execute a method, and the method comprises:
applying a speed scaling factor associated with a low mobility state of a user equipment (UE) to an idle mode processing parameter in response to the UE is in the low mobility state, wherein the idle mode processing parameter is utilized for a criterion for triggering a specific idle mode operation in the idle mode, and the low mobility state is a state where a speed of the UE is lower than a first speed threshold; and
adjusting the criterion using the speed scaling factor to delay or skip execution of the specific idle mode operation.
